(19) United States
(12) Patent Application Publication
(10) Pub. No.: US 2020/0303082 A1
(43) Pub. Date: Sep. 24, 2020

(54) Honeycomb-shaped fuel assembly cooled by liquid chloride salt and reactor core using this assembly

(71) Applicant: XI'AN JIAOTONG UNIVERSITY, Xi'an (CN)

(72) Inventors: Liangzhi Cao, Xi'an (CN); Shengcheng Zhou, Xi'an (CN); Hongchun Wu, Xi'an (CN); Tiejun Zu, Xi'an (CN); Chi Lei, Xi'an (CN); Yifan Zhang, Xi'an (CN)

(73) Assignee: XI'AN JIAOTONG UNIVERSITY

(21) Appl. No.: 16/897,271

(22) Filed: Jun. 10, 2020

(30) Foreign Application Priority Data
Jul. 8, 2019 (CN) 201910609286.6

(51) Int. Cl. G21C 3/04; G21C 15/28; G21C 3/08; G21C 3/62

(52) U.S. Cl. CPC G21C 3/042; G21C 15/28; G21C 3/62; G21C 3/044; G21C 3/08

(57) ABSTRACT

A honeycomb-shaped fuel assembly cooled by liquid chloride salt adopts a honeycomb-shaped structure. A fuel coolant is a mixture of liquid three-phase chloride salt NaCl—KCl—MgCl₂. Fuel is U₃Si₂ with an enrichment of 19.75% or 16.0%. The fuel assembly includes: fuel coolant channel pipelines which vertically penetrate and laterally merge, a fuel coolant contained in the fuel coolant channel pipelines, a fuel zone, upper and lower endcap, a top gas plenum, and upper and lower endcap. A reflector assembly adopts a honeycomb-shaped structure, including: reflector coolant pipes which are vertically penetrating; a reflector coolant contained in the reflector coolant pipes; a titanium reflector; and upper and lower endcaps. A control assembly and a safety assembly adopt a rod bundle structure using B₄C with a natural enrichment of ¹⁰B as absorbers.

### CROSS REFERENCE OF RELATED APPLICATION

The present invention claims priority under 35 U.S.C. 119(a-d) to CN 201910609286.6, filed Jul. 8, 2019.

### BACKGROUND OF THE PRESENT INVENTION

### Field of Invention

The present invention relates to a technical field of nuclear reactor engineering, and more particularly to a honeycomb-shaped fuel assembly cooled by liquid chloride salt and a small reactor core using this assembly.

### Description of Related Arts

Small modular reactors (SMRs) have remarkable market potential. It is expected that by 2035, the market size of SMRs will be about 65-85 GWe. Liquid three-phase chloride salt NaCl—KCl—MgCl₂, as a new type of coolant, has the following advantages: transparent, relatively low melting point (396° C.), high boiling point (about 1400° C.), low density, low viscosity, high specific heat capacity, being stable under irradiation conditions, good compatibility with reactor materials, weak neutron moderation, low thermal expansion coefficient and high chemical inertness. Liquid three-phase chloride salt NaCl—KCl—MgCl₂ is used as coolant for SMRs design, which is conducive to the design of compact and light reactors and the transportation, safe operation and deployments of SMRs.

### SUMMARY OF THE PRESENT INVENTION

An object of the present invention is to provide a honeycomb-shaped fuel assembly cooled by liquid chloride salt and a small reactor core using this assembly, wherein rated thermal power of the reactor core is 40 MW; the reactor core can be operated for 10 effective full power years without refueling, and can be transported by vehicle or ship.

Accordingly, in order to accomplish the above object, the present invention provides:

a honeycomb-shaped fuel assembly cooled by liquid chloride salt, comprising: a fuel assembly box (8); fuel coolant channel pipelines (9) which vertically penetrate the fuel assembly box (8), laterally merge with each other, and arranged in a triangular layout; and a fuel coolant (5) contained in the fuel coolant channel pipelines (9); wherein the fuel coolant channel pipelines (9) have holes for laterally merging with each other with the fuel coolant (5); parts in the fuel assembly box (8) but outside the fuel coolant channel pipelines (9) comprises, from a bottom to a top: a fuel lower endcap (7), a fuel lower reflector (6), a fuel zone (4), a fuel gas plenum (3), a fuel upper reflector (2) and a fuel upper endcap (1); the fuel coolant (5) is a mixture of liquid three-phase chloride salt NaCl—KCl—MgCl₂.

The fuel coolant channel pipelines (9) have 37 pipes.

The fuel zone (4) uses U₃Si₂ with an enrichment of 19.75% or 16.0% as fuel; the fuel upper reflector (2) and the fuel lower reflector (6) are both made of titanium; the fuel upper endcap (1), the fuel lower endcap (7), the fuel assembly box (8) and the fuel coolant channel pipelines (9) are all made of Hastelloy.

The present invention also provides a reactor core cooled by liquid chloride salt, comprising: inner fuel assemblies (12), outer fuel assemblies (13), control assemblies (10), safety assemblies (11), reflector assemblies (14), and shielding assemblies (15); wherein the inner fuel assemblies (12) and the outer fuel assembly (13) are both honeycomb-shaped fuel assemblies cooled by the liquid chloride salt; the inner fuel assemblies (12) use U₃Si₂ with an enrichment of 16.0% as fuel, and the outer fuel assemblies (13) use U₃Si₂ with an enrichment of 19.75% as fuel; radial power distribution of the reactor core is flattened by zoning; assemblies of the reactor core are arranged in a triangular layout, wherein 31 inner fuel assemblies (12) are arranged in first to fourth circles of the reactor core; 3 control assemblies (10) and 3 safety assemblies (11) are arranged symmetrically and uniformly in the third circle; 54 outer fuel assemblies (13) are arranged in fifth to seventh circles; 12 control assemblies (10) are arranged symmetrically and uniformly in the fifth circle; 42 reflector assemblies (14) are arranged in seventh to eighth circles; and 48 shielding assemblies (15) are arranged in the eighth to ninth circles; reactor core coolant gaps are reserved between the assemblies in the reactor core, and a reactor core coolant is a mixture of liquid three-phase chloride salt NaCl—KCl—MgCl₂.

Each of the reflector assemblies (14) adopts a honeycomb-shaped structure, comprising: a reflector assembly box (16-1); reflector coolant pipes (19-1) which are vertically penetrating; a reflector coolant (18-1) contained in the reflector coolant pipes (19-1); a titanium reflector (17-1); a reflector upper seal endcap (20-1); and a reflector lower endcap (21-1); wherein the titanium reflector (17-1) is filled outside the reflector coolant pipes (19-1) in the reflector assembly box (16-1); the reflector upper endcap (20-1) and the reflector lower endcap (21-1) are arranged on a top and a bottom of the titanium reflector (17-1), respectively; each of the shielding assemblies (15) adopts the same structure of the reflector assemblies (14), comprising: a shielding assembly box (16-2); shielding coolant pipes (19-2) which are vertically penetrating; a shielding coolant (18-2) contained in the shielding coolant pipes (19-2); a B₄C shield (17-2) with a natural enrichment of ¹⁰B; a shielding upper endcap (20-2); and a shielding lower endcap (21-2).

Both the reflector coolant pipes (19-1) and the shielding coolant pipes (19-2) have 19 pipes.

The control assemblies (10) and the safety assemblies (11) adopt a rod bundle structure using B₄C with a natural enrichment of ¹⁰B as absorbers; the control assemblies (10) and the safety assemblies (11) have same structures and same material compositions; each of the control assemblies (10) and the safety assemblies (11) comprises: an assembly box (22); absorber rods (24) and absorber rod cladding (25) evenly distributed in the assemblies box (22); and a coolant (23) filled outside the absorber rod cladding (25) in the assembly box (22); wherein each of the absorber rods (24) comprises, from a bottom to a top: a lower reflector (29), the B₄C absorber rods (24), a gas plenum (28) and an upper reflector (27); wherein upper endcap (26) and lower endcap (30) are provided at tops and bottoms, respectively, of the control assemblies (10) and the safety assemblies (11).

Each of the control assemblies (10) and the safety assemblies (11) comprises 7 absorber rods (24).

The reactor core is operated at an atmospheric pressure; the reactor core coolant has a rated inlet temperature of 496° C. and a rated outlet temperature of 596° C.

Compared with the current technology, the present invention has advantages as follows.

1. The present invention uses the mixture of the liquid three-phase chloride salt NaCl—KCl—MgCl₂ as the coolant, which has the advantages of transparent medium, low density, high boiling point, radiation resistance, high chemical inertness, etc. Compared with conventional liquid metal cooled reactors, the transparent medium is convenient for supervision and maintenance of the reactor. The low density makes the reactor light and easy to transport. The high chemical inertness and radiation resistance make the reactor safe, which can simplify reactor safety facilities and reduce costs.

2. The present invention uses the honeycomb-shaped fuel assembly. The coolant channels vertically penetrate and merge laterally, which eliminates conventional assembly grid spacer and wire wrap, so that fuel volume ratio of the assembly is increased and coolant content is reduced. Meanwhile, lateral mergence between the coolant channels prevents local fuel temperature from being too high due to local coolant channel blockage, and avoids coolant pipe melting or even fuel melting.

3. Two fuel assemblies with different fuel enrichment are arranged in the reactor core fuel zone, which can effectively flatten the core radial power distribution.

4. The reflector is made of metal titanium with low density, strong corrosion resistance, and lowered neutron reflectance as neutron energy spectrum becomes harder, which can significantly reduce positive void reactivity of the coolant.

5. Throughout the core lifetime, the coolant temperature is always below 850° C., which has a weak corrosion effect on the coolant channel pipes and structural materials. A maximum temperature at a fuel center is below 1400° C. Fast neutron fluence of cladding and the structural materials is lower than 3.3 E+23 n/cm².

By adopting the mixture of the liquid three-phase chloride salt NaCl—KCl—MgCl₂ as the coolant, the invention significantly reduces the weight of the reactor, making it convenient for transportation by vehicle or ship. Without refueling, the reactor core can be operated for 10 effective full power years

### BRIEF DESCRIPTION OF THE DRAWINGS

FIG. 1 is an axial section view of gap portions of a honeycomb-shaped assembly;

FIG. 2 is an A-A cross-sectional view according to FIG. 1;

FIG. 3 is a B-B cross-sectional view according to FIG. 1;

FIG. 4 is a cross-sectional view of a reactor core;

FIG. 5 is a cross-sectional view of a reflector assembly;

FIG. 6 is an axial section view of gap portions of the reflector assembly;

FIG. 7 is a cross-sectional view of a shielding assembly;

FIG. 8 is an axial section view of gap portions of the shielding assembly;

FIG. 9 is a cross-sectional view of a control assembly.

FIG. 10 is a height-direction section view of active areas of the control assembly.

### DETAILED DESCRIPTION OF THE PREFERRED EMBODIMENT

Referring to drawings and embodiments, the present invention will be further illustrated as follows.

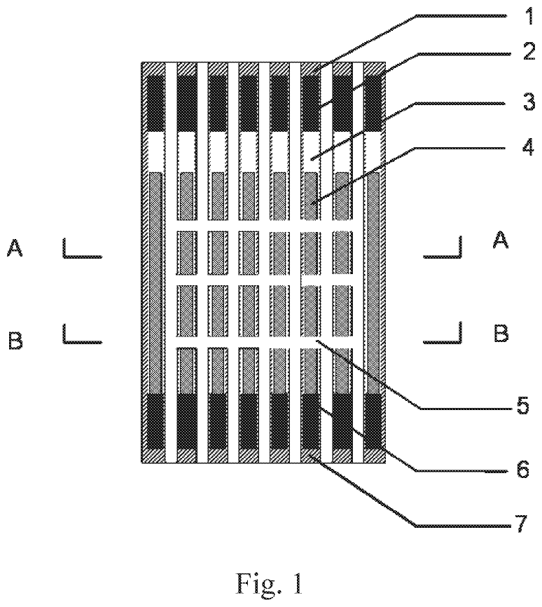

Referring to FIG. 1, the present invention provides a honeycomb-shaped fuel assembly cooled by liquid chloride salt, comprising: a fuel assembly box 8; fuel coolant channel pipelines 9 which vertically penetrate the fuel assembly box 8, laterally merge with each other, and arranged in a triangular layout; and a fuel coolant 5 contained in the fuel coolant channel pipelines 9; wherein the fuel coolant channel pipelines 9 have holes for laterally merging with each other with the fuel coolant 5; parts in the fuel assembly box 8 but outside the fuel coolant channel pipelines 9 comprises, from a bottom to a top: a fuel lower endcap 7, a fuel lower reflector 6, a fuel zone 4, a fuel assembly gas plenum 3, a fuel upper reflector 2 and a fuel upper endcap 1; the fuel upper and lower endcap heights are 5 cm; the fuel lower reflector height is 20 cm; the active core height is 70 cm, the gas plenum 3 height is 60 cm, and the fuel upper reflector 2 height is 10 cm.

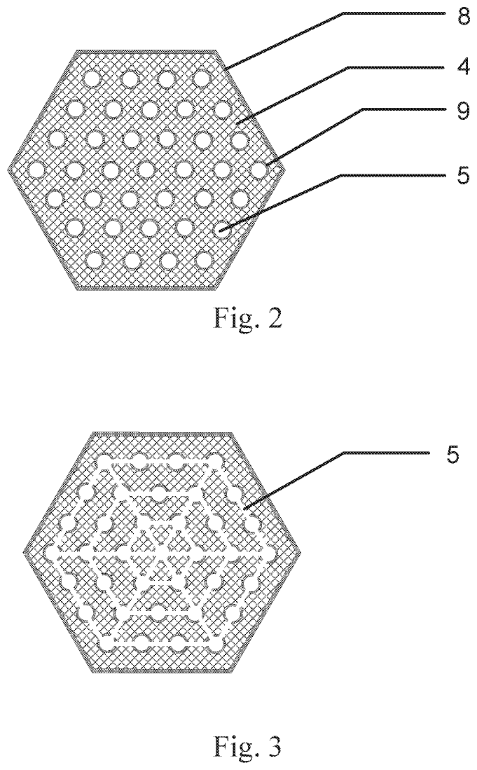

Referring to FIGS. 2 and 3, the fuel coolant 5 is a mixture of liquid three-phase chloride salt NaCl—KCl—MgCl₂. Coolant channels are formed by the fuel coolant channel pipelines 9 which vertically penetrate, laterally merge, and arranged in the triangular layout; the fuel coolant channel pipelines 9 have 37 pipes; the fuel assembly pitch is 12 cm; a gap thickness between the fuel assemblies is 0.4 cm; a thickness of the fuel assembly box 8 is 0.3 cm; the coolant pipe outer diameter is 0.95 cm; the coolant pipe thickness is 0.035 cm; and the coolant pipe pitch is 1.76 cm.

As the preferred embodiment of the invention, the fuel zone 4 uses U₃Si₂ with an enrichment of 19.75% or 16.0% as fuel.

As the preferred embodiment of the present invention, the fuel upper reflector 2 and the fuel lower reflector 6 are both made of titanium; the fuel upper endcap 1, the fuel lower endcap 7, the fuel assembly box 8 and the fuel coolant channel pipelines 9 are all made of Hastelloy.

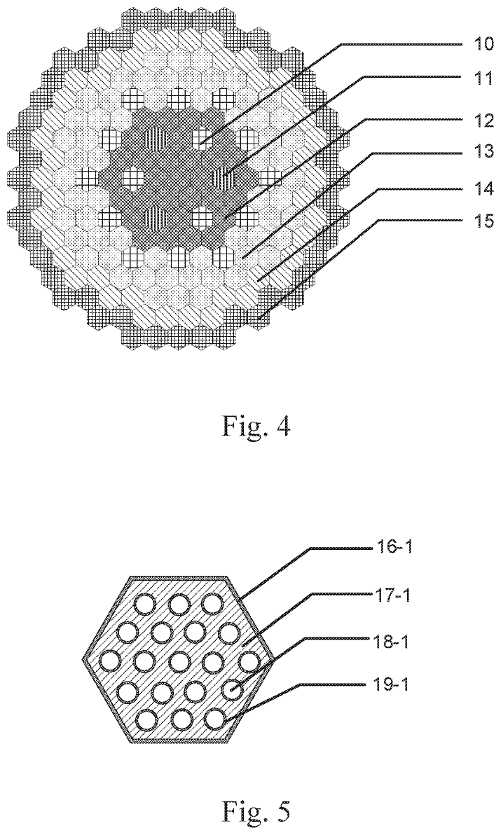

Referring to FIG. 4, the present invention also provides a reactor core cooled by liquid chloride salt, comprising: inner fuel assemblies 12, outer fuel assemblies 13, control assemblies 10, safety assemblies 11, reflector assemblies 14, and shielding assemblies 15; wherein the inner fuel assemblies 12 and the outer fuel assemblies 13 are both honeycomb-shaped fuel assemblies cooled by the liquid chloride salt; the inner fuel assemblies 12 use U₃Si₂ with an enrichment of 16.0% as fuel, and the outer fuel assemblies 13 use U₃Si₂ with an enrichment of 19.75% as fuel; radial power distribution of the reactor core is flattened by zoning; assemblies of the reactor core is arranged in a triangular layout, wherein 31 inner fuel assemblies 12 are arranged in first to fourth circles of the reactor core; 3 control assemblies 10 and 3 safety assemblies 11 are arranged symmetrically and uniformly in the third circle; 54 outer fuel assemblies 13 are arranged in fifth to seventh circles; 12 control assemblies 10 are arranged symmetrically and uniformly in the fifth circle; 42 reflector assemblies 14 are arranged in seventh to eighth circles; and 48 shielding assemblies 15 are arranged in the eighth to ninth circles.

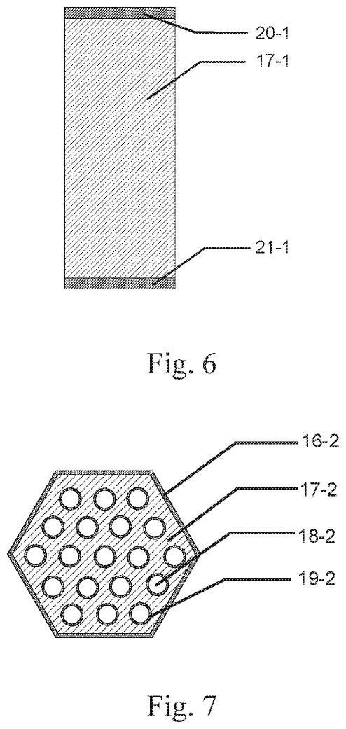

Referring to FIGS. 5-6, each of the reflector assemblies 14 adopts a honeycomb-shaped structure, comprising: a reflector assembly box 16-1; reflector coolant pipes 19-1 which are vertically penetrating; a reflector coolant 18-1 contained in the reflector coolant pipes 19-1; a titanium reflector 17-1; a reflector upper endcap 20-1; and a reflector lower endcap 21-1; wherein the titanium reflector 17-1 is filled outside the reflector coolant pipes 19-1 in the reflector assembly box 16-1; the reflector upper endcap 20-1 and the reflector lower endcap 21-1 are arranged on a top and a bottom of the titanium reflector 17-1, respectively; the reflector upper endcap 20-1 and the reflector lower endcap 21-1 height is 5 cm, the titanium reflector 17-1 height is 60 cm; the reflector coolant pipe 19-1 outer diameter is 0.868 cm; the reflector coolant pipe 19-1 pitch is 2.464 cm; and the reflector coolant pipe 19-1 thickness is 0.035 cm; the reflector coolant pipes 19-1 have 19 pipes.

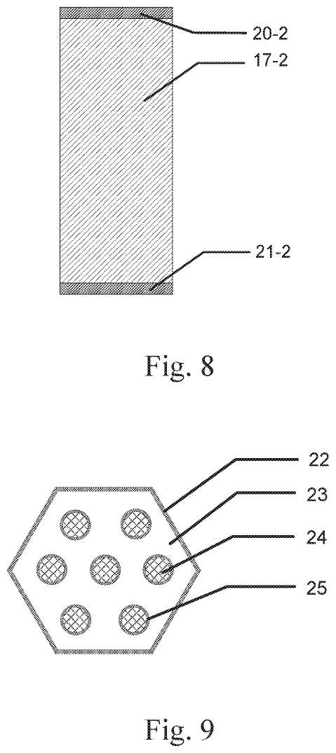

Referring to FIGS. 7 and 8, each of the shielding assemblies 15 adopts the same structure of the reflector assemblies 14, comprising: a shielding assembly box 16-2; shielding coolant pipes 19-2 which are vertically penetrating; a shielding coolant 18-2 contained in the shielding coolant pipes 19-2; a B₄C shield 17-2 with a natural enrichment of ¹⁰B; a shielding upper endcap 20-2; and a shielding lower endcap 21-2; the shielding upper endcap 20-2 and the shielding lower endcap 21-2 height is 5 cm, the B₄C shield 17-2 with the natural enrichment of ¹⁰B height is 60 cm; the shielding coolant pipe 19-2 outer diameter is 0.868 cm; the shielding coolant pipe 19-2 pitch is 2.464 cm; and the shielding coolant pipe 19-2 thickness is 0.035 cm; the shielding coolant pipes 19-2 have 19 pipes.

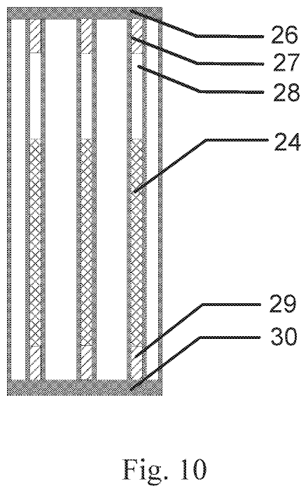

Referring to FIGS. 9 and 10, the control assemblies 10 and the safety assemblies 11 adopt a rod bundle structure using the B₄C with the natural enrichment of ¹⁰B as absorbers; the control assemblies 10 and the safety assemblies 11 have same structures and same material compositions; each of the control assemblies 10 and the safety assemblies 11 comprises: an assembly box 22; absorber rods 24 and absorber rod cladding 25 evenly distributed in the assemblies box 22; and a coolant 23 filled outside the absorber rod cladding 25 in the assembly box 22; wherein each of the absorber rods 24 comprises, from a bottom to a top: a lower reflector 29, the B₄C absorber rods 24, a gas plenum 28 and an upper reflector 27; wherein upper endcap 26 and lower endcap 30 are provided at tops and bottoms, respectively, of the control assemblies 10 and the safety assemblies 11; the upper and lower endcap height are 5 cm; the lower reflector 29 height is 20 cm; the B₄C absorber rods 24 height is 70 cm; the gas plenum 28 height is 60 cm; the upper reflector 27 height is 10 cm; the control assembly pitch is 12 cm; the absorber rod 24 outer diameter is 1.267 cm; the absorber rod cladding 25 thickness is 0.035 cm; the absorber rods 24 quantity is 7; and a gap thickness of the absorber rods 24 is 0.052 cm.

The present invention provides a honeycomb-shaped fuel assembly cooled by liquid chloride salt and a small reactor core using this assembly, wherein rated thermal power of the reactor core is 40 MW; the reactor core can be operated for 10 effective full power years without refueling, and can be transported by vehicle or ship. The reactor core adopts the honeycomb-shaped fuel assembly cooled by liquid chloride salt, which is divided into two radial zones to arrange two kinds of fuel assemblies. The reactor core can satisfy thermal limit during service life. And the reactor core has a small core volume, light weight, vehicle-transportable, long life and high safety.

What is claimed is:

1. A honeycomb-shaped fuel assembly cooled by liquid chloride salt, comprising: a fuel assembly box (8); fuel coolant channel pipelines (9) which vertically penetrate the fuel assembly box (8), laterally merge with each other, and arranged in a triangular layout; and a fuel coolant (5) contained in the fuel coolant channel pipelines (9); wherein the fuel coolant channel pipelines (9) have holes for laterally merging with each other with the fuel coolant (5); parts in the fuel assembly box (8) but outside the fuel coolant channel pipelines (9) comprises, from a bottom to a top: a fuel lower endcap (7), a fuel lower reflector (6), a fuel zone (4), a fuel assembly gas plenum (3), a fuel upper reflector (2) and a fuel upper endcap (1);
the fuel coolant (5) is a mixture of liquid three-phase chloride salt NaCl—KCl—MgCl₂.

2. The honeycomb-shaped fuel assembly, as recited in claim 1, wherein the fuel coolant channel pipelines (9) have 37 pipes.

3. The honeycomb-shaped fuel assembly, as recited in claim 1, wherein the fuel zone (4) uses U₃Si₂ with an enrichment of 19.75% or 16.0% as fuel; the fuel upper reflector (2) and the fuel lower reflector (6) are both made of titanium; the fuel upper endcap (1), the fuel lower endcap (7), the fuel assembly box (8) and the fuel coolant channel pipelines (9) are all made of Hastelloy.

4. A reactor core cooled by liquid chloride salt, comprising: inner fuel assemblies (12), outer fuel assemblies (13), control assemblies (10), safety assemblies (11), reflector assemblies (14), and shielding assemblies (15); wherein the inner fuel assemblies (12) and the outer fuel assemblies (13) are both honeycomb-shaped fuel assemblies cooled by the liquid chloride salt; the inner fuel assemblies (12) use U₃Si₂ with an enrichment of 16.0% as fuel, and the outer fuel assemblies (13) use U₃Si₂ with an enrichment of 19.75% as fuel; radial power distribution of the reactor core is flattened by zoning; assemblies of the reactor core is arranged in a triangular layout, wherein 31 inner zone fuel assemblies (12) are arranged in first to fourth circles of the reactor core; 3 control assemblies (10) and 3 safety assemblies (11) are arranged symmetrically and uniformly in the third circle; 54 outer fuel assemblies (13) are arranged in fifth to seventh circles; 12 control assemblies (10) are arranged symmetrically and uniformly in the fifth circle; 42 reflector assemblies (14) are arranged in seventh to eighth circles; and 48 shielding assemblies (15) are arranged in the eighth to ninth circles; reactor core coolant gaps are reserved between the assemblies in the reactor core, and a reactor core coolant is a mixture of liquid three-phase chloride salt NaCl—KCl—MgCl₂.

5. The reactor core, as recited in claim 4, wherein each of the reflector assemblies (14) adopts a honeycomb-shaped structure, comprising: a reflector assembly box (16-1); reflector coolant pipes (19-1) which are vertically penetrating; a reflector coolant (18-1) contained in the reflector coolant pipes (19-1); a titanium reflector (17-1); a reflector upper endcap (20-1); and a reflector lower endcap (21-1); wherein the titanium reflector (17-1) is filled outside the reflector coolant pipes (19-1) in the reflector assembly box (16-1); the reflector upper endcap (20-1) and the reflector lower endcap (21-1) are arranged on a top and a bottom of the titanium reflector (17-1), respectively; each of the shielding assemblies (15) adopts the same structure of the reflector assemblies (14), comprising: a shielding assembly box (16-2); shielding coolant pipes (19-2) which are vertically penetrating; a shielding coolant (18-2) contained in the shielding coolant pipes (19-2); a B₄C shield (17-2) with a natural enrichment of ¹⁰B; a shielding upper endcap (20-2); and a shielding lower endcap (21-2).

6. The reactor core, as recited in claim 5, wherein both the reflector coolant pipes (19-1) and the shielding coolant pipes (19-2) have 19 pipes.

7. The reactor core, as recited in claim 4, wherein the control assemblies (10) and the safety assemblies (11) adopt a rod bundle structure using B₄C with a natural enrichment of ¹⁰B as absorbers; the control assemblies (10) and the safety assemblies (11) have same structures and same material compositions; each of the control assemblies (10) and the safety assemblies (11) comprises: an assembly box (22); absorber rods (24) and absorber rod cladding (25) evenly distributed in the assemblies box (22); and a coolant (23) filled outside the absorber rod cladding (25) in the assembly box (22); wherein each of the absorber rods (24) comprises, from a bottom to a top: a lower reflector (29), the B₄C absorber rods (24), a gas plenum (28) and an upper reflector (27); wherein upper endcap (26) and lower endcap (30) are provided at tops and bottoms, respectively, of the control assemblies (10) and the safety assemblies (11).

8. The reactor core, as recited in claim 7, wherein each of the control assemblies (10) and the safety assemblies (11) comprises 7 absorber rods (24).

9. The reactor core, as recited in claim 4, wherein the reactor core is operated at an atmospheric pressure; the reactor core coolant has a rated inlet temperature of 496° C. and a rated outlet temperature of 596° C.
